(19) United States
(12) Patent Application Publication
(10) Pub. No.: US 2005/0147702 A1
(43) Pub. Date: Jul. 7, 2005

(54) Die insert for extruder

(75) Inventor: Kouji Higashi, Osaka (JP)

Correspondence Address: JORDAN AND HAMBURG LLP, 122 EAST 42ND STREET, SUITE 4000, NEW YORK, NY, 10168, US

(73) Assignee: Toyo Tire & Rubber Co., Ltd., Osaka-shi (JP)

(21) Appl. No.: 11/005,913

(22) Filed: Dec. 6, 2004

(30) Foreign Application Priority Data
Jan. 6, 2004 (JP) 2004-1464

(51) Int. Cl. B29C 47/02

(52) U.S. Cl. 425/113

(57) ABSTRACT

The invention contemplates to provide a die insert for an extruder, which can suppress the motions of cords at a rubber topping time to improve the disturbance of the cord array pitch of a topping sheet drastically thereby to improve the homogeneity and quality of the topping sheet. In the die insert 1 for the extruder, cord slots 11 are provided at their exit portions with flat faces 14 having channels 11a leading to the cord slots 11 at a die insert leading end portion 12, and the channels 11a for passing a cord array 21 are formed open in the flat faces 14. The channels 11a in the flat faces 14 preferably have a ratio of L/D of 1 to 20 between their open length (L) and diameter (D), and the flat faces 14 are preferably formed to have a step S between the surface side and the back side of the cord array 21.

### TECHNICAL FIELD

The present invention relates to a die insert for an extruder, i.e., a topping jig for manufacturing a topping sheet by topping a cord array having a plurality of tire cords arranged at a predetermined pitch, on its surface and back face with rubber without disturbing the array pitch.

### BACKGROUND ART

In the prior art, a cord reinforcing material constructing the carcass or belt layer of a pneumatic tire is exemplified by a topping sheet which is prepared by topping the two faces of a cord array of a tire fabric having cords arranged in parallel, with unvulcanized rubber. For this topping sheet, there is widely used the so-called calender topping method, in which the cord array is topped through calender rolls arranged in a Z-shape while forming rubber sheets by feeding the rolls with preheated rubber.

However, this calender apparatus is required to include: large-scaled devices in which upstream and downstream of the calender rolls is equipped with a device for letting off rolled cords of the tire fabric and for taking up the topping sheet; and a pretreatment device such as rubber heating rolls, so that it requires a high cost for the facilities and a wide installation area. At the topping time, moreover, the let-off of the cords, the feed of rubber and the turning speeds of the calender rolls have to be adjusted in relation to one another. This adjustment raises problems that skills are required for keeping the topping precision, and that a plurality of workers are required to deteriorate the workability.

Therefore, the technique for manufacturing a band-shaped topping sheet by means of a rubber extruder for topping the two faces of the cord array arrayed at a predetermined pitch by a die insert, with rubber has been proposed in JP-A-6-106595, JP-A-6-114911 or JP-A-2003-11205. This proposed technique is advantageous in that it has a small scale for the facilities and is suited for flexible productions, and in that it can solve the aforementioned problems in the cost and area for the facilities.

In the aforementioned manufacture of the topping sheet using the extruder of the prior art, as shown for example in FIG. 13, a vertically symmetric die insert 9 having cord slots 91 formed at a predetermined pitch P, as shown in FIG. 12, for arraying a plurality of cords 2 at the pitch is arranged in a die head 4 of the rubber extruder so that the cord array 21 is formed. After this, unvulcanized rubber coming from the (not-shown) extruder is fed to a topping chamber 44 between the die insert 9 and a die throat 3 from rubber passages 42 and 43 via rubber feed passages 45 and 46 so that the cord array 21 is topped on its two faces to manufacture a topping sheet 23.

In the structure of the prior art shown in FIG. 13 and having the die insert 9 used in the extruder head 4 for the rubber topping operation in the topping chamber 44, however, no means for regulating the individual cords of the cord array 21 exists between the cord slot exits 91 of the die insert 9 and the die throat 3. As shown in FIG. 14, therefore, the individual cords 2 are topped with such rubber while rocking vertically and transversely in the topping chamber 44 as is fed vertically but is heterogeneous in amount and flow due to the pressure fluctuations and the pulsations. As a result, there arises a problem that the cord array in the topping sheet 23 is irregularly disturbed vertically and transversely in the longitudinal direction of the sheet 23 as shown in FIG. 15. Other problems are that a small-wave roughness W is made on the surface of the sheet 23 on the basis of the array disturbances of the cords thereby to degrade the surface properties, and that an uneven tension acts on the cords due to the deterioration of the flow of the unvulcanized rubber thereby to leave heterogeneous residual distortions on the individual cords 2 in the topping sheet 23. Moreover, this homogeneity failure of the topping sheet 23 degrades the quality of the pneumatic tire, that is, affects the durability performance or the uniformity adversely.

The present invention contemplates to solve the above-specified problems and to prevent the motions of cords effectively, as might otherwise be caused by the heterogeneous rubber flow in the topping chamber between the die insert and the die throat in the die head of the extruder, and has an object to provide a die insert for an extruder, which can suppress the motions of cords effectively at a topping time to improve the disturbance of the cord array pitch of a topping sheet drastically thereby to improve the topping precision by the simple improvement in the structure of the die insert and the homogeneity and quality of the topping sheet.

### DISCLOSURE OF THE INVENTION

According to the invention as set forth in claim 1, there is provided a die insert for an extruder, comprising cord slots for inserting and arraying a plurality of cords at a predetermined interval, and used together with a die throat arranged in the die head of the extruder for determining the shape of topping rubber, so that it may top the surface and back face of a cord array with the rubber coming from said extruder, thereby to top both sides of said cord array, characterized in that the exit portions of the cord slots of said die insert are formed so that they may top the surface side of said cord array with the rubber and then the back side of said cord array with the rubber.

As set forth in claim 2, moreover, the exit portions of the cord slots of said die insert are provided with flat faces having channels leading to said cord slots at the leading end portion of said die insert, and said channels to be passed by said cord array are formed open in said flat faces, so that the invention can be easily practiced.

In this case, it is preferable that the channels in said flat faces have a ratio L/D of 1 to 20 between the open length (L) of the channels and the diameter (D) of the channels.

Moreover, said flat faces are formed to have a step between the surface side and the back side of said cord array. As a result, the die insert is so simplified in shape at its cord exit side that it can be easily manufactured. At the same time, the die insert is so hardly broken or deformed/cracked that it becomes excellent in durability.

According to the die insert for the extruder of the invention, the cord array prepared by the die insert is fed on its surface side with the rubber when it comes out of the slot exits of the die insert, so that it is topped on its one face without its array pitch being disturbed, such that the individual cords are pushed by the rubber onto the bottoms of the upward open channels formed in the flat faces of the leading end portion of the die insert. After this, the cord array is topped on its back face with the rubber while passing the topping chamber while constraining the motions of the cords, so that the cord array is topped on both faces with the rubber. As a result, the topping operation is not affected by the heterogeneous rubber flow, as exemplified by the fluctuations or pulsations of the amount or pressure of the fed rubber, so that the positions of the cords cannot be disturbed transversely and vertically to provide a topping sheet having a high cord array precision and excellent surface properties. Moreover, the tension, as might otherwise be caused to act on the cords by the flow of the rubber, can be lightened to reduce the residual strain of the cords in the topping sheet thereby to improve the handling of the topping sheet.

According to the die insert for the extruder of this invention, the motions of the cords at the topping time are effectively suppressed by the simple improvement in the shape of the extruder head thereby to improve the disturbances of the cord array of the topping sheet drastically. Thus, the die insert have an excellent effect in that it can manufacture the topping sheet which is so improved in the cord array precision in the transverse and vertical directions in the sheet as to have excellent homogeneity and quality, thereby to provide the weft-less cord reinforcing material to be properly used in the pneumatic tire, easily and inexpensively. Moreover, the die insert for the extruder of the invention can be practiced by the simple improvement in the structure, thereby to improve the topping precision of the topping sheet without any high cost that might otherwise be required for modifications of another topping jig or the inside of the die head.

### BRIEF DESCRIPTION OF THE DRAWINGS

FIG. 1 presents a front elevation and a side elevation of a die insert of a mode of embodiment.

FIG. 2 is an enlarged side elevation of the leading end portion of the same die insert.

FIG. 3 is a sectional view showing a state of the same die insert used in an extruder die head.

FIG. 4 is a schematic view showing a state of cords in a topping chamber using the same die insert.

FIG. 5 is an explanatory diagram showing the actions of the same die insert.

FIG. 6 is a perspective view of a topping sheet of an embodiment.

FIG. 7 presents a front elevation and a longitudinal section showing a die throat.

FIG. 8 presents a front elevation and a side elevation of a die insert of a first modification.

FIG. 9 presents a front elevation and a side elevation of a die insert of a second modification.

FIG. 10 presents a front elevation and a side elevation of a die insert of a third modification.

FIG. 11 presents a front elevation and a side elevation of a die insert of a fourth modification.

FIG. 12 presents a front elevation and a side elevation of a die insert of a prior art example.

FIG. 13 is a sectional view showing a state of the same die insert used in an extruder die head.

FIG. 14 is a schematic view showing a state of cords in a topping chamber using the same die insert.

FIG. 15 is a perspective view of a topping sheet of the prior art example.

### BEST MODE FOR CARRYING OUT THE INVENTION

A mode of embodiment of the invention will be described with reference to the accompanying drawings.

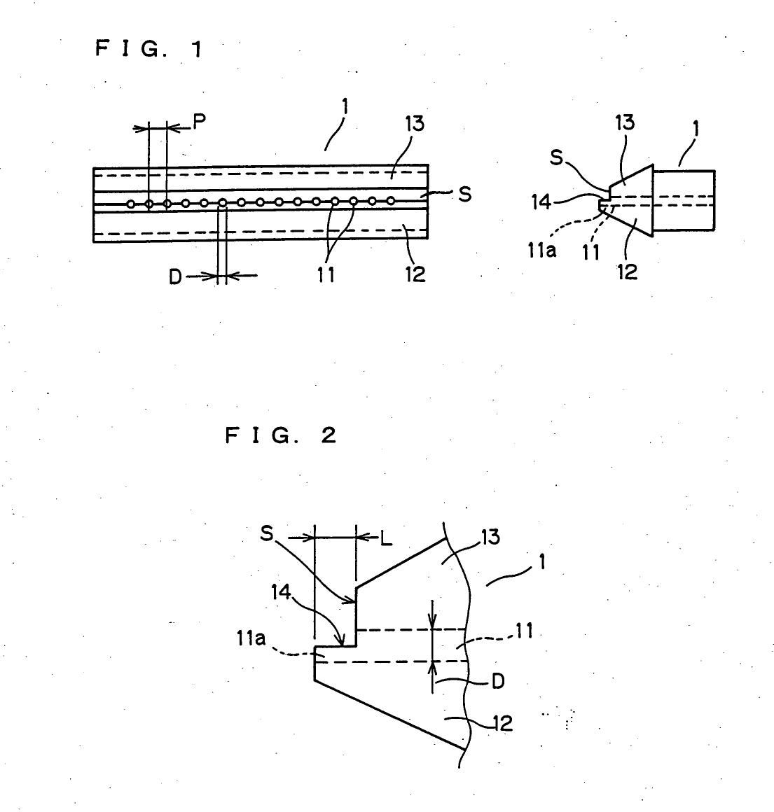

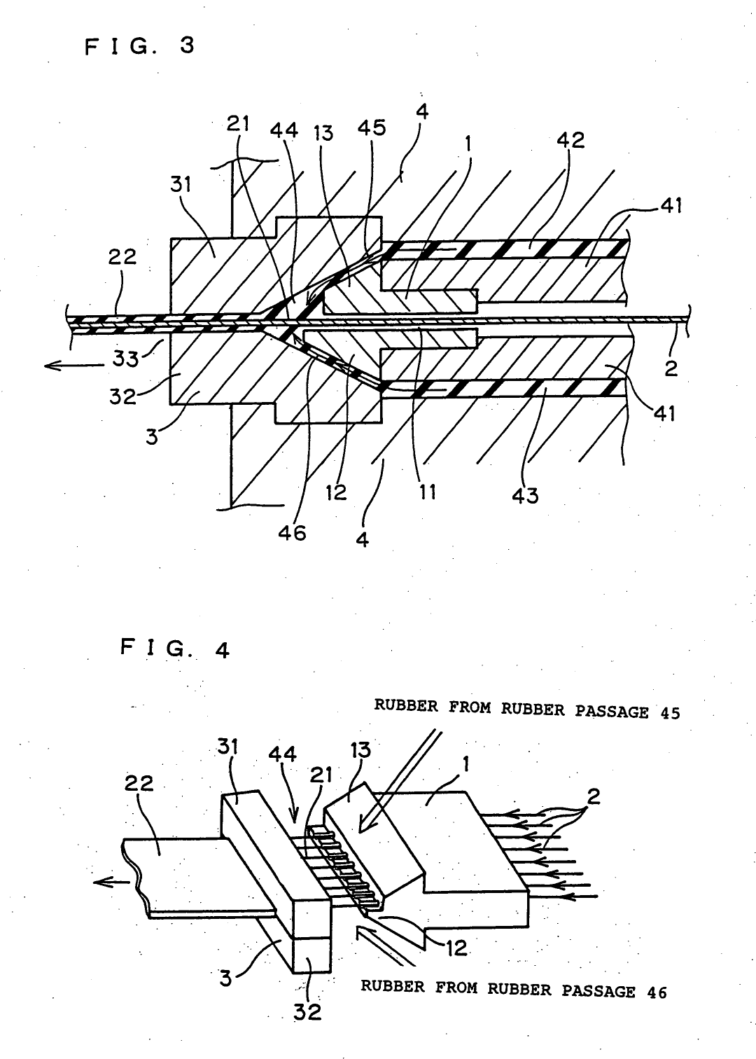

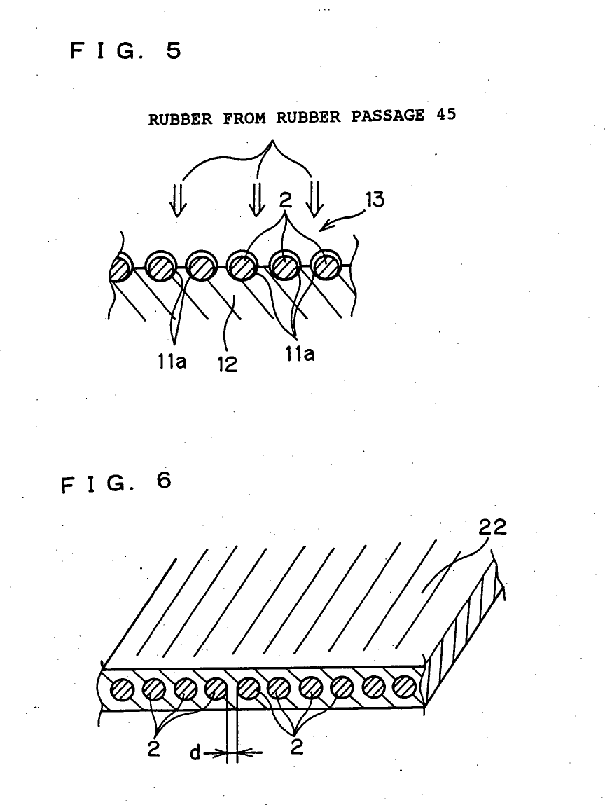

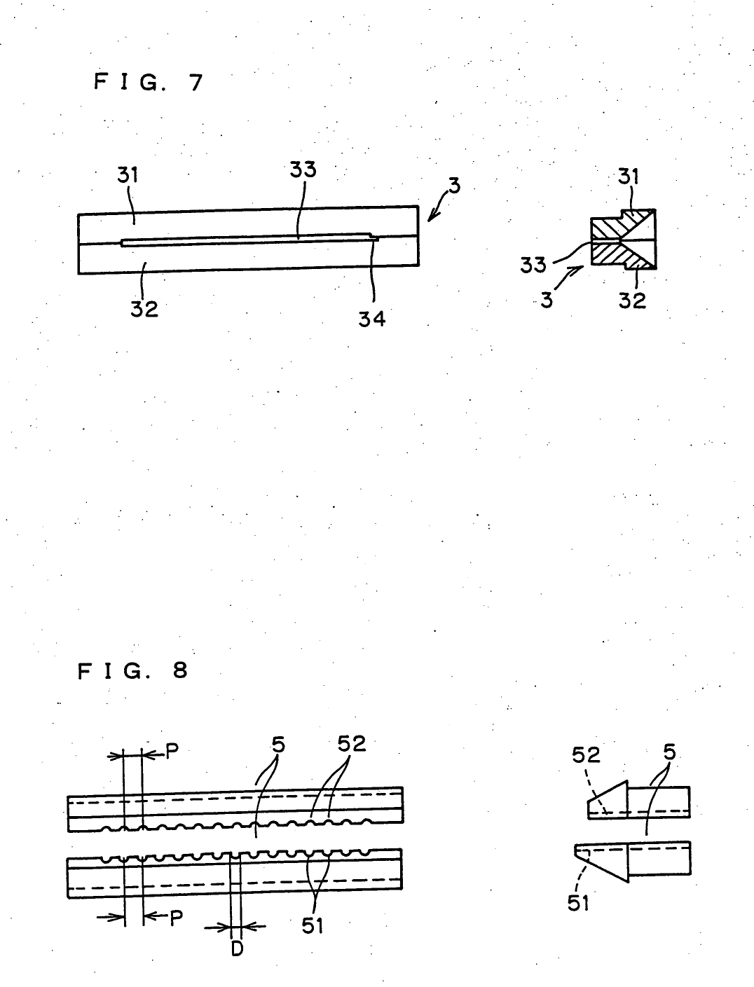

FIG. 1 presents a front elevation and a side elevation of a die insert 1 according to a mode of embodiment of the invention; FIG. 2 is an enlarged diagram of the leading end portion of the die insert 1; FIG. 3 is a sectional view of the inside of an extruder die head; FIG. 4 is a schematic view showing a state of cords in a topping chamber 44 formed in a spacing between the die insert 1 and a die throat 3; FIG. 5 is an explanatory diagram showing the actions by the die insert 1; FIG. 6 is a perspective view of a topping sheet 22; and FIG. 7 presents a front elevation and a longitudinal section showing the die throat 3.

Generally, the die insert for an extruder is a jig for forming a cord array, in which a plurality of tire cords are arranged and arrayed in parallel at a predetermined pitch, in an extruder head. The die insert is a metallic jig, in which cord slots for inserting the plural cords are opened at the predetermined pitch in a common plane.

On the other hand, the die throat is a metallic mouthpiece for extruding a composite of the cords rubber-coated on the two faces of the cord array and unvulcanized rubber, from the extruder head. As shown in FIG. 7, the die throat 3 is composed of an upper die throat 31 and a lower die throat 32, and a rectangular opening portion 33 adjusted to the shape of thickness and width of the topping sheet 22 to be extrusion-molded is so formed between those two members as to have a joint allowance 34 at its one end portion.

By using the die insert and the die throat combined with each other and arranged longitudinally in the extruder head, the cord array is topped on its both faces with the unvulcanized rubber fed from the extruder so that a band-shaped topping sheet having predetermined cord density, thickness and width can be extruded/shaped and continuously manufactured.

The die insert 1 for the extruder of the invention is opened in a common plane at a predetermined pitch P with circular cord slots 11 for inserting a plurality of cords 2, as shown in FIG. 1 and FIG. 2, to form a cord array 21, in which the cords 2 are arranged in parallel at the predetermined pitch. The internal diameter D of the cord slots 11 is made so slightly larger than the cord diameter as can insert the cords 2 smoothly.

The die insert 1 is clamped and fixed, when used, in the head 4 of the extruder vertically by holders 41. The die insert 1 has its leading end portion formed to have a generally triangular section so as to form rubber feed passages 45 and 46 for feeding the rubber from the extruder through the upper and lower rubber passages 42 and 43 into the topping chamber 44 formed in the spacing between the die insert 1 and the inner opening portion of the die throat 3.

Moreover, the die insert 1 is provided with flat faces 14 having channels 11a leading to the cord slots 11. The channels 11a are opened upward in the flat faces 14 to pass the cord array having left the exit portions of the cord slots 11.

At the exit portions of the cord slots 11, more specifically, the leading end portion of the die insert 1 is divided across the flat faces 14 into a leading end portion 12 on the under side (corresponding to the back side of the cord array) and a leading end portion 13 on the upper side (corresponding to the surface side of the cord array). The lower leading end portion 12 is protruded forward from the upper leading end portion 13 to form the flat faces 14 so that the channels 11a of the lower leading end portion, through which the cord array 21 passes, are exposed to the flat faces 14. Therefore, the channels 11a are formed into a semicircular section having the same diameter D as that of the cord slots 11.

As shown in FIGS. 3 and 4, the die insert 1 is fixed in the die head 4 by the upper and lower holders 41. The die insert 1 is used together with the die throat 3 for determining the shape of the topping rubber. The die insert 1 feeds the unvulcanized rubber fed from the rubber extruder, to the topping chamber 44 from the surface and back sides of the cord array 21 via the rubber feed passages 45 and 46 leading from the upper and lower rubber passages 42 and 43 formed between the head 4 and the holder 41. The die insert 1 tops the two faces of the cord array 21 with the fed unvulcanized rubber, and extrudes the cord array 21 from the opening portion 33 of the die throat 3, so that the band-shaped topping sheet 22 having predetermined thickness and width is continuously manufactured.

By using this die insert 1, the cord array 21 is topped at first on its upper side surface with the rubber fed from the rubber feed passage 45, when it passes the exit portion of the cord slots 11, that is, at the leading end portion of the die insert in the channels 11a opened upward in the flat faces 14 of the lower leading end portion 12 of the die throat 3. After having passed the channels 11a of the lower leading end portion 12, the cord array 21 is topped in the topping chamber 44 on its under side surface side with the rubber fed from the rubber feed passage 46. Thus, the cord array 21 is topped on its two faces to form the topping sheet 22.

While passing the channels 11a in the flat faces 14 of the die insert 1, the cord array 21 is topped exclusively on its upper side surface with the rubber coming from the rubber feed passage 45. As a result, the individual cords 2 of the cord array 21 are topped, as shown in FIG. 5, while being pushed by the rubber pressure onto the bottoms of the channels 11a in the flat faces 14 of the die insert leading end portion 12. As a result, the cord array 21 is coated with the rubber while its individual cords 2 being fixed on the channel bottoms so that it is topped on its one face without disturbing its array pitch.

From the viewpoint of positioning the cords 2, it is preferable that the bottoms of the channels 11a opened in the flat faces 14 have a U-shaped, V-shaped or semicircular section.

Therefore, the cord array 21 is topped on its under side surface with the rubber coming from the rubber feed passage 46, while it is passing the topping chamber 44 with its individual cords being fixed in constrained states at the predetermined positions for the one-face topping operation. Thus, the cord array 21 is topped on its two faces to provide the topping sheet 22 which has such a high cord array precision that the cord array in the sheet is set longitudinally constant at predetermined transverse and vertical positions.

The ratio of L/D of the open length (L) to the diameter (D) of the channels 11a in the flat faces 14 at the leading end portion 12 of the die insert 1 is about 1 to 20, preferably within a range of 8 to 15.

If the ratio L/D is less than 1, the pressing force of the die insert leading end portion 12 into the bottoms of the channels 11a becomes so insufficient that the cords are allowed to move easily in the channels 11a , and the one-face topping becomes so ineffective that the array pitch is disturbed due to influences of the rubber flow in the topping chamber 44 due to shortage of adhesion of the rubber and the cords 2. If the ratio L/D exceeds 20, a higher cord constraining effect cannot be expected, and the execution for the excess ratio is made difficult, too, due to the structure of the die insert.

Here, it is easy and general for working the die insert 1 that the cord slots 11 and the open channels 11a are continuously formed to have the equal internal diameter D and the identical sectional shape. However, the internal diameter of the cord slots 11 and the diameter or sectional shape of the open channels 11a can adopt different values and different sectional shapes, if they can improve the effects of the invention better.

Moreover, the flat faces 14 containing the opened cord channels 11a are formed to have a step S between the surface side and the back side of the cord array 21. As a result, the shape of the cord output side of the die insert 1 can be simplified to facilitate its manufacture, and especially the leading end portion of the die insert 1 can be hardly broken or deformed/cracked to have an excellent durability.

As a result, the cord array 21 being topped is not affected by the heterogeneous rubber flow, as exemplified by the fluctuations or pulsations of the amount or pressure of the rubber fed from the two rubber feed passages 45 and 46. Therefore, it is possible to improve the topping precision thereby to provide the topping sheet 22 which keeps its transverse and vertical arrays of the cords constant in the longitudinal direction and which has a flat shape and homogenous characteristics, as shown in FIG. 6.

Moreover, the tension to act on the individual cords 2 is reduced to make the cord interval constant. In addition, the residual distortion of the individual cords 2 in the topping sheet 22 is lightened to reduce the warpage and floating of the topping sheet 22 when this sheet is cut, so that the cutting failure or the joint failure can be reduced to give an excellent handling for improving the manufacturing steps and the member precisions.

Moreover, the die insert for the extruder of the invention is enabled to improve the topping precision by improving its structure simply, so that it can be easily exemplified without any unnecessary cost for modifying the topping jig or the die head inside or for improving or changing the extruder control method.

Modifications of Die Insert

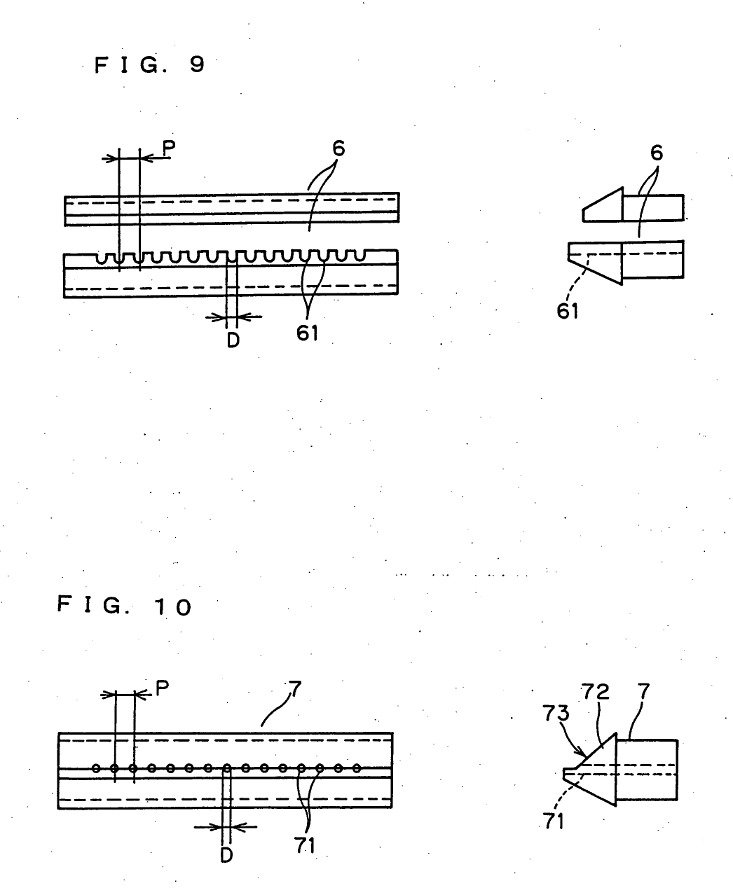

The die insert thus far described should not be limited to the integral structure, as shown in FIG. 1, but may be modified into other two-split structures. In the two-split structure, as shown in FIG. 8, a die insert 5 is provided at the predetermined pitch P with cord channels 51 and 52 having generally semicircular sections in the inner face side. In the two-split structure shown in FIG. 9, on the other hand, one inner face side is provided at the predetermined pitch P with cord channels 61 having a generally semicircular bottom face, and the other inner face is shaped into a flat face.

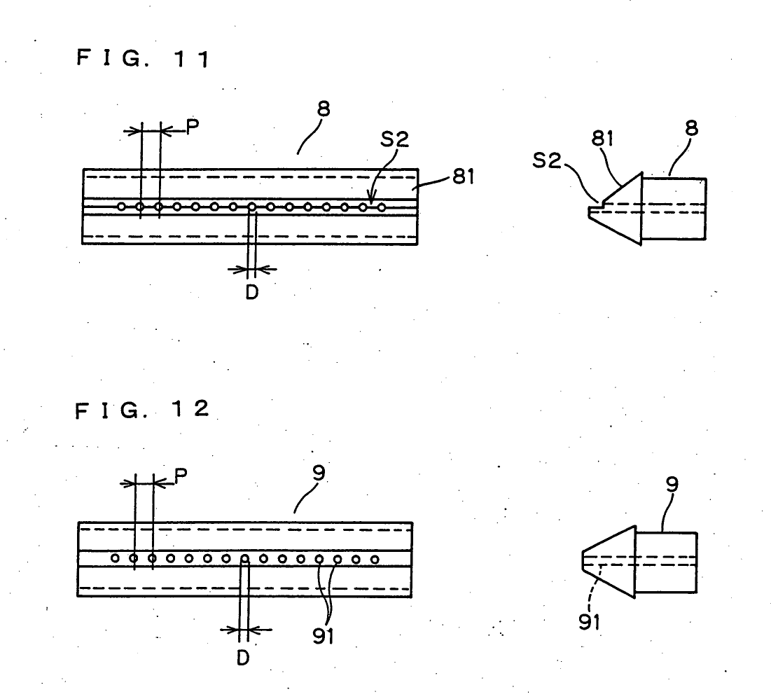

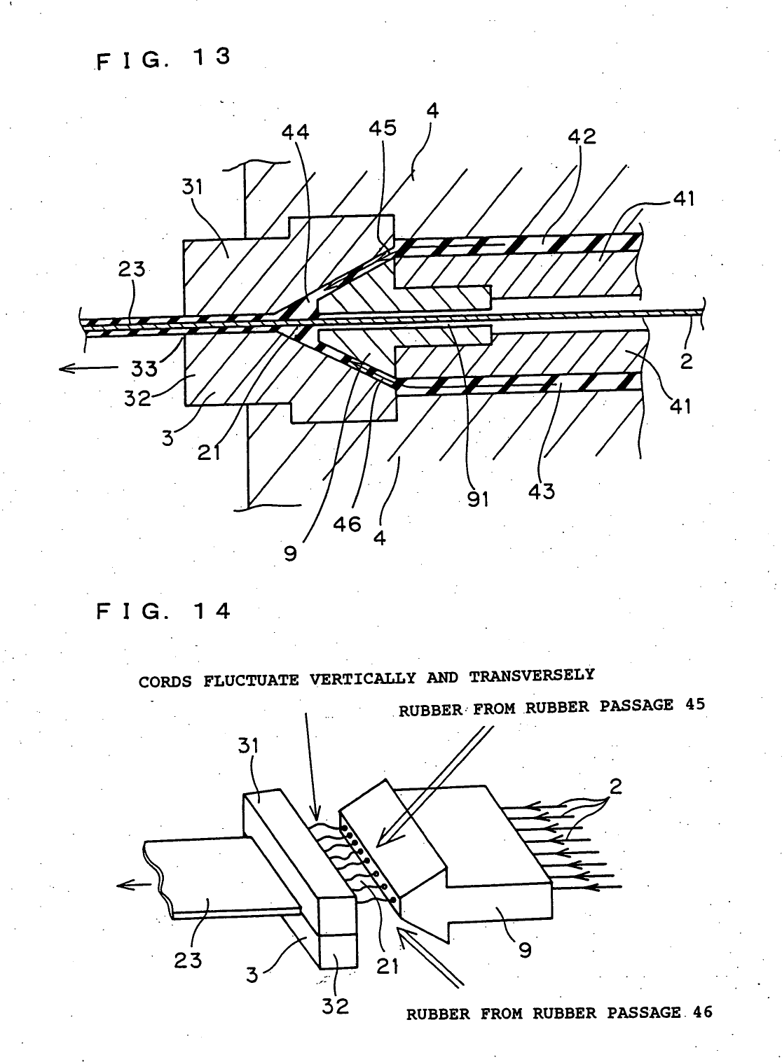

In a die insert 7 shown in FIG. 10, on the other hand, no step is formed at the exit portions of cord slots 71 of the die insert 7, but one leading end portion 72 is formed into a slope 73 leading to the cord array. In this modification, the flow and pressure of the rubber to be fed can be easily adjusted by changing the shape of the rubber feed passage along the slope 73, and the amount of rubber to be fed can be adjusted to regulate the abutment of the cords against the channels by changing the gradient of the slope.

Moreover, the die insert can also be modified into a die insert 8, as shown in FIG. 11, in which the die insert 8 has a structure using both a slope 81 and a step S2 capable of adjusting the flow rate and pressure of the rubber to the array cords, in addition to being provided with step at the exit portions of the cord slots. Thus, die inserts of various shapes can be adopted without departing from the object of the invention.

The cords 2 to be used in the topping sheet manufactured by using the die insert for the extruder of the invention can be exemplified by various tire cords of multifilament yarns and monofilament yarns, for example, metallic fiber cords such as steel cords, organic fiber cords of polyester, nylon, aramid or rayon, or inorganic fiber cords of carbon fibers or glass fibers. The cords 2 can construct the weft-less topping sheet which is suited for the tire reinforcing layer such as the carcass or belt layer of a pneumatic tire.

Here, the foregoing embodiment has been described on the basis of the case, in which the cord array is topped on its upper side surface and then on its under side surface. Of course, the under side surface may be topped at first, and the upper side surface may be topped later. This modification can be easily executed by designing the sectional shape of the die insert upside down.

### EXAMPLE

The die insert was prepared by using treated tire cords (having a cord diameter of 0.67 mm) of polyester of 1,670 dtex/2, forming 100 cord slots (having the internal diameter D=0.85 mm) at an equal pitch in the die insert shown in FIG. 1, providing a step S, and by changing the ratio of L/D of the open length (L) and the diameter (D) of the channels 11a formed continuously in the identical shape from the cord slots. The die insert thus prepared was arranged in the extruder die head shown in FIG. 3 to manufacture the topping sheet having a topping width of 100 mm and a thickness of 1.1 mm.

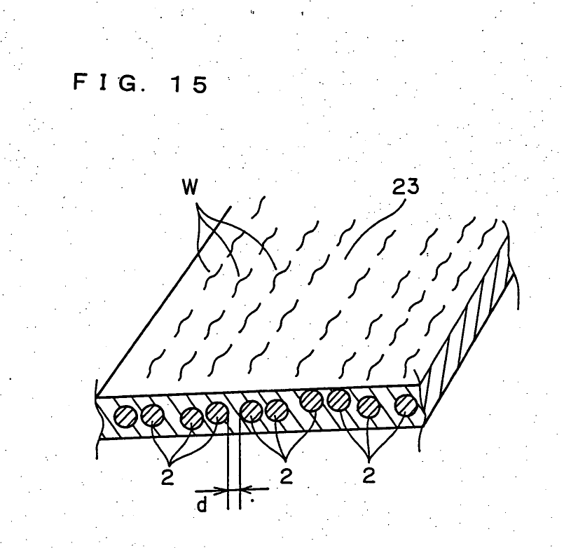

The cord distance d (as referred to FIGS. 6 and 15) of the topping sheet obtained was randomly measured at five portions in the longitudinal direction and at twenty portions in the transverse direction (i.e., the total measurements=100), and a coefficient of variation (%) was determined from the average value and the standard deviation of the measured cord distance values. Moreover, the state of the sheet surface was observed. These results are enumerated in Table 1. For the smaller coefficient of variation, the cord distance is the less disturbed and the more satisfied.

TABLE 1

| Die Insert | | |
|---|---|---|
| Example | Comparison | Prior Art |

| | | | |
|---|---|---|---|
| Slot Open Length L | 10 | 0.7 | 0 |
| (mm) | | | |
| Slot Diameter D (mm) | 0.85 | 0.85 | 0.85 |
| L/D | 11.8 | 0.8 | 0 |
| Coefficient of Variation | 1.4 | 7.6 | 12.4 |
| (%) of Cord Distance | | | |
| Surface State of | Flatness | Small-Wave | Small-Wave |
| topping Sheet | Good | Roughness | Roughness Large |
| | | Medium | |
| Reference Figures | | | |

As apparently found, the topping sheet manufactured by using the die insert of the embodiment according to the invention has a smaller coefficient of variation than those of Comparison and Prior Art to keep the cord distance equivalent in the topping sheet, so that the die insert of the invention can improve the cord array disturbance during the topping drastically. Moreover, the topping sheet surface has no wavy roughness on the topping sheet surface unlike Prior Art so that the sheet quality is improved.

### INDUSTRIAL APPLICABILITY

The die insert for the extruder of this invention is enabled by the simple improvement in the structure to suppress the motions of the cords at the rubber topping time in the extruder head thereby to improve the cord array disturbance of the topping sheet drastically. Thus, the weft-less topping sheet improved in the cord array precision and the quality of the sheet can be efficiently manufactured and used as the reinforcing material for the individual portions of the pneumatic tire, such as the carcass, the belt, the belt reinforcing layer or the side wall.

1. A die insert for an extruder, comprising cord slots for inserting and arraying a plurality of cords at a predetermined interval, and used together with a die throat arranged in the die head of the extruder for determining the shape of topping rubber, so that the die insert tops an upper face and back an under face of a cord array with the rubber coming from said extruder, thereby to top both sides said faces of said cord array, the cord slots of said die insert are having exit portions formed so that they effect said topping of said upper face of said cord array with the rubber and then effect said topping of said under face of said cord array with the rubber.

2. A die insert for an extruder as set forth in claim 1, wherein:
the exit portions of the cord slots of said die insert are have flat faces having channels leading to said cord slots at the a leading end potion of said die insert; and said channels are to be passed by said cord array and are formed open in said flat faces.

3. A die insert for the extruder as set forth in claim 2, wherein:
the channels in said flat faces have a ratio L/D of 1 to 20 between the an open length (L) of the channels the a diameter (D) of the channels.

4. A die insert for an extruder as set forth in claim 2 or 3, wherein:
said flat faces are formed to have a step between the upper face and the under face of said cord array.
